(19) United States
(12) Patent Application Publication
(10) Pub. No.: US 2006/0105720 A1
(43) Pub. Date: May 18, 2006

(54) Signal interface for a wireless device

(76) Inventor: Vijay K. Nair, Mesa, AZ (US)

Correspondence Address: TROP PRUNER & HU, PC, 8554 KATY FREEWAY, SUITE 100, HOUSTON, TX, 77024, US

(21) Appl. No.: 10/992,130

(22) Filed: Nov. 18, 2004

(51) Int. Cl. H04B 1/46

(52) U.S. Cl. 455/80; 455/78

(57) ABSTRACT

A technique includes selectively coupling lines of a signal interface to a radio frequency front end device and a device other than the radio frequency front end device. The technique includes terminating unselected lines of the signal interface.

### BACKGROUND

The invention generally relates to a signal interface for a wireless device.

A wireless device, such as a cellular telephone or a personal digital assistant (PDA) that has wireless capability, typically includes a radio frequency (RF) front end device (often called an “RF-FE”), an integrated circuit that forms an interface for the wireless device to one or more antennas. The RF front end device typically drives the antenna(s) with RF signals when the wireless device 10 is transmitting and receives RF signals from the antenna(s) when the wireless device 10 is receiving. The RF front end device may include such circuits as low noise amplifiers, mixers, voltage controlled oscillators (VCOs) and power amplifiers. It is not uncommon for a conventional RF front end device to perform a single radio function, such as a radio function related to a particular cellular telephone standard or a function related to establishing the wireless device in a wireless local area network (WLAN).

More recent RF front end devices, however, may perform multiple radio and other functions. For example, a cellular telephone may have an RF front end device that performs the dual radio functions of communicating over a cellular network and communicating over a WLAN. Furthermore, the RF front end device may perform other functions, such as GPS-related activities. As the number of functions of the RF front end device increases, the complexity of the external signal interface to the RF front end device also increases. Therefore, it may become increasingly difficult to integrate an RF front end device with other components of a wireless device.

Thus, there exists a continuing need for better ways to integrate an RF front end device that has multiple radio functions and possibly other functions with other components of a wireless device.

### BRIEF DESCRIPTION OF THE DRAWING

FIG. 1 is a block diagram of a wireless device according to an embodiment of the invention.

FIG. 2 is a top view of a signal interface between an RF front end device and an RF integrated circuit of the wireless device according to an embodiment of the invention.

FIG. 3 is a cross-sectional view taken along lines 3-3 of FIG. 2 according to an embodiment of the invention.

FIGS. 4 and 5 are block diagrams illustrating different connections between the RF integrated circuit and the RF front end device according to different embodiments of the invention.

### DETAILED DESCRIPTION

In accordance with some embodiments of the invention, a wireless device (a cellular telephone or personal digital assistant (PDA) that has wireless capabilities) may include a radio frequency (RF) front end device (a chip set, a single integrated package or a multichip module, as just a few examples), often referred to as an “RF-FE,” that performs several different functions, such as voice, data, video and camera functions. Furthermore, the RF front end device may be capable of communicating in accordance with multiple wireless standards and thus, many perform different radio functions. For example, in accordance with some embodiments of the invention, the RF front end device may be a “universal communicator” in that the device may be capable of communicating as part of a wireless wide area network (“WWAN”), communicating pursuant to a communication protocol pursuant to Institute of Electrical and Electronic Engineers (IEEE) Specification 802.16 (called “Wimax”), communicating as part of a wireless local area network (called “WLAN”), communicating as part of a wireless personal area network (called “WPAN”) and functioning as a global positioning satellite (GPS) receiver.

Integrating these functions into the RF front end device involves several complex interconnection issues. For example, the manufacturer of the RF front end device may use an arbitrary, proprietary or otherwise non-standard design for the external signal interfaces to the front end device. Furthermore, the higher the number of radio functions, the greater the chance of unpredictable RF interferences in the external signal connections to the RF front end device. Additionally, proprietary designs for the external signal interface of the RF front end device may lead to vertically-integrated architectures that hinder platform innovation.

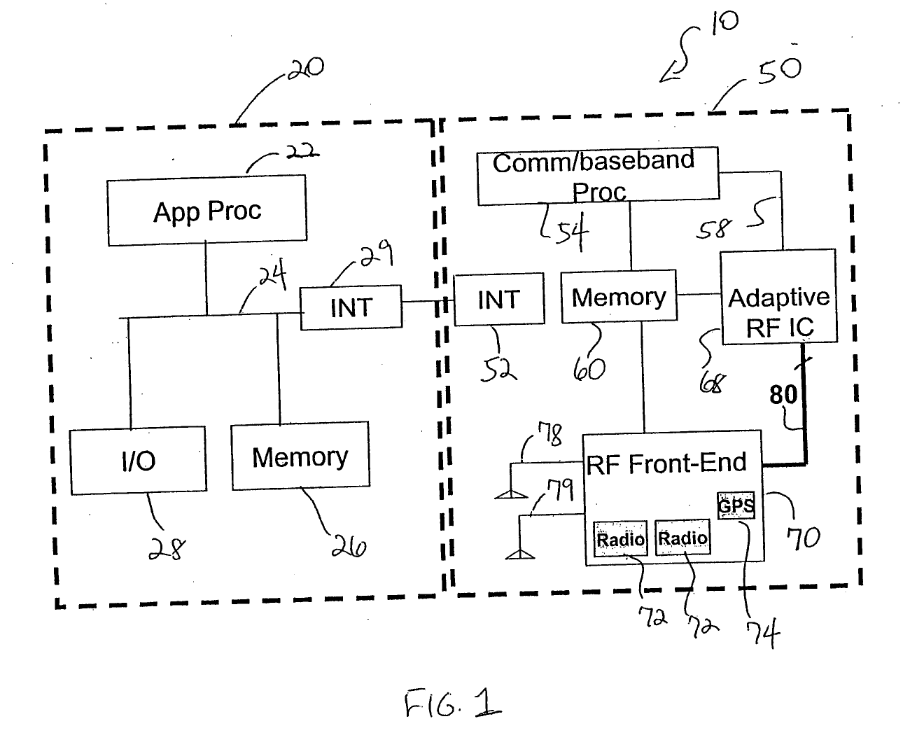

Referring to FIG. 1, therefore, in accordance with an embodiment of the invention, a wireless device 10 includes a standardized signal interface 80 between an RF front end device 70 and an adaptive RF integrated circuit 68 of the wireless device 10. The RF front end device 70 forms an interface for the wireless device 10 to one or more antennas 78 and 79 (dipole antennas, for example) of the device 10. More specifically, for its receive path, the RF front end device 70 includes such features as an antenna switch to select between the appropriate antenna; low noise amplifiers to receive the RF signals from the antennas 78 and 79; bandpass filters; and possibly mixers to demodulate the received RF signals to lower frequency signals before providing these signals to the RF integrated circuit 68. For its transmit path, the RF front end device 70 may use the antenna switch to select the appropriate antenna and may include such other features as power amplifiers to drive the selected antenna 78 and 79; bandpass filters; and possibly mixers to modulate the signals that drive the antennas 78 and 79.

Depending on the particular RF front end device 70 being used, the device 70 communicates RF and/or intermediate frequency (IF) signals with the RF integrated circuit 68. The RF integrated circuit 68, in turn, performs modulation (for its transmit path) and demodulation (for its receive path) for purposes of communicating baseband signals with a processor 54, in some embodiments of the invention. However, in other embodiments of the invention, the RF integrated circuit 68 may also contain a baseband processor. Therefore, depending on the particular embodiment of the invention, the processor 54 may be a baseband processor that controls baseband processing as well as controls operations of a communication subsystem 50 (of the wireless device 10) or a communication processor 54 that controls operation of the communication subsystem 50 without performing any baseband processing. In some embodiments of the invention, the processor 54 may be combined with the RF integrated circuit 68 as a chip set, a single integrated package or a multichip module, as just a few examples.

The RF front end device 70 may be made by many different manufacturers, and as a result, the external signals that the RF front end device 70 uses to communicate with the RF integrated circuit 68 may depend on the manufacturer and the functions that the device 70 provides. However, the same signal interface 80 to the RF front end device 70 is used, regardless of the number of functions (radio and otherwise) that are performed by the RF front end device 70 and regardless of the manufacturer of the device 70. Thus, due to the standardized signal interface 80, open architectures are enabled that foster platform innovation. Furthermore, a standard interface, such as the interface 80, minimizes issues related to radio interoperability, radio co-existence and RF interferences due to uncontrolled termination characteristics. In some embodiments of the invention, the RF front end device 70 may be a system in a package (SIP) or a system on a chip (SOC).

As described further below, the signal interface 80 includes communication lines that are laid out in an arrangement to minimize RF interference between the communication lines, whether or not all of the communication lines are actually used by the RF front end device 70 in its communication with the RF integrated circuit 68. In some embodiments of the invention, as further described below, unused communication lines of the interface 80 are terminated (coupled to ground, terminated through an RF terminating resistor or coupled to a voltage supply line, as just a few examples). Thus, the signal interface 80 provides the structure for the appropriate connections to the RF front end device 70 regardless of the functions and manufacturer of the RF front end device 70.

In some embodiments of the invention, the wireless device 10 may be a cellular telephone or a device (such as a personal digital assistant (PDA), notebook computer, camera, etc.) that has wireless capabilities and possibly other capabilities that are not related to wireless communication. The wireless device 10 may be generally viewed as including an application subsystem 20 and the communication subsystem 50.

The RF front end device 70 is part of the communication subsystem 50 and may include multiple radios 72 and a GPS receiver 74 (as examples), in some embodiments of the invention. The radios 72 may include any combination of the radios (WWAN, Wimax, etc.) that are listed above. The RF front end device 70 may include an antenna switch (not depicted in FIG. 1) for purposes of selectively connecting the antennas 78 and 79 to the appropriate radio 72 or the GPS receiver 74 when the particular function implemented by the selected entity is being used.

The communication/baseband processor 54 communicates with registers of the RF integrated circuit 68 (over a communication link 58); and the processor 54 is also coupled to a memory 60 (a flash memory, for example). In some embodiments of the invention, the memory 60 may also communicate with the RF integrated circuit 68 directly. The communication subsystem 50 may also include an interface 52 that communicates with an interface 29 of the application subsystem 20 to pass information between these two subsystems.

The application subsystem 20, as its name implies, executes application programs (an email application, a web surfing application, an address contact list, a speed-dial list, etc.) for the wireless device 10. The application subsystem 20 includes an application processor 22 that executes instructions associated with the various applications stored in a memory 26 (a flash memory, for example) of the application subsystem 20. The memory 26 and the application processor 22 communicate over a system bus 24 that is coupled to the interface 29. Furthermore, the application subsystem 20 may include, for example, an input/output (I/O) interface 28 for purposes of establishing an interface with a user of the wireless device 10. For example, depending on the particular embodiment of the invention, the I/O interface 28 may form an input interface for receiving input data from a keypad or touchscreen, may provide audio signals to a speaker of the wireless device, may provide an output signal to a headphone that is coupled to the wireless device 10, may provide video signals to drive a display of the wireless device 10, etc.

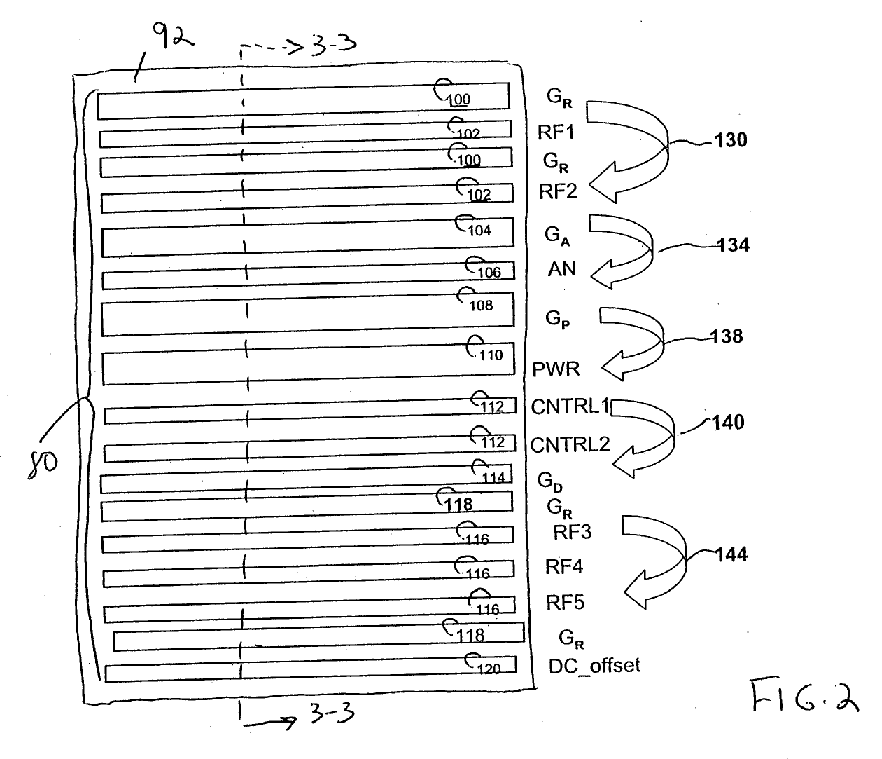

Referring to FIG. 2, in some embodiments of the invention, the signal interface 80 may be formed on a printed circuit board (PCB) 92 substrate and may include various analog and digital communication lines that extend between the RF front end device 70 and the RF integrated circuit 68.

For example, these communication lines may include one or more sets 130 (one set 130 being depicted in FIG. 2) of communication lines that form a coplanar waveguide. A coplanar waveguide is formed from the following three adjacent communication lines that are part of the same metal layer: two ground communication lines and a signal path communication line that extends beside and is located between the two ground communication lines. More specifically, the exemplary set 130 that is depicted in FIG. 2 includes RF communication lines 102 (labeled “RF1” and “RF2”) and ground lines 100. The ground lines 100 are situated so that the two ground lines 100 and the RF1 communication line 102 form a coplanar waveguide. It is noted that the RF2 communication line 102 is located between one of the ground lines 100 and an adjacent ground line 104 of another set 134 of communication lines (described below), thereby providing the structure for another coplanar waveguide.

Besides the ground line 104, the set 134 of communication lines also includes an analog signal communication line 106 that is adjacent to the ground line 104. The communication lines 104 and 106 may be used for purposes of communicating lower frequency (intermediate frequency (IF), for example) signals. Thus, the ground line 104 may serve the dual function of being an analog ground for IF signals as well as an RF ground for a coplanar waveguide (as described above).

As examples of other types of communication lines, in some embodiments of the invention, the signal interface 80 may include a set 144 of communication lines that form multiple RF microstrip lines. An RF microstrip line is formed from an RF communication line and a corresponding ground plane that is located on a lower layer of the PCB 92 beneath the RF communication line. As depicted in FIG. 2, the set 144 includes, as an example, RF communication lines 116 (labeled “RF3,” “RF4,” and “RF5”), each of which in conjunction with the ground plane (not depicted in FIG. 2) that is located below in the PCB 92 form a respective microstrip line. Ground lines 118 that are coupled by vias to this lower ground plane extend on each side of the RF3, RF4 and RF5 communication lines 116.

The standardized signal interface 80 may also include other communication lines and sets of communication lines for purposes of establishing control and providing power to the RF front end device 70 and/or RF integrated circuit 68. For example, in some embodiments of the invention, the signal interface 80 may include a DC offset line 120. As another example, in some embodiments of the invention, the signal interface 80 may include a set 138 of lines that provide power to circuitry that is connected to the interface 80, such as the RF front end device 70 (for example). More specifically, in some embodiments of the invention, the set 138 of communication lines may include a ground line 108 and a DC power line 110. Furthermore, in some embodiments of the invention, the signal interface 80 may include a set 140 of digital control lines, such as digital control communication lines 112.

The embodiment of the signal interface 80, which is depicted in FIG. 2 is one out of many possible embodiments of the invention. Thus, the signal interface 80 may include different waveguides, RF, analog and digital communication lines and may be arranged differently than is depicted in FIG. 2, in other embodiments of the invention.

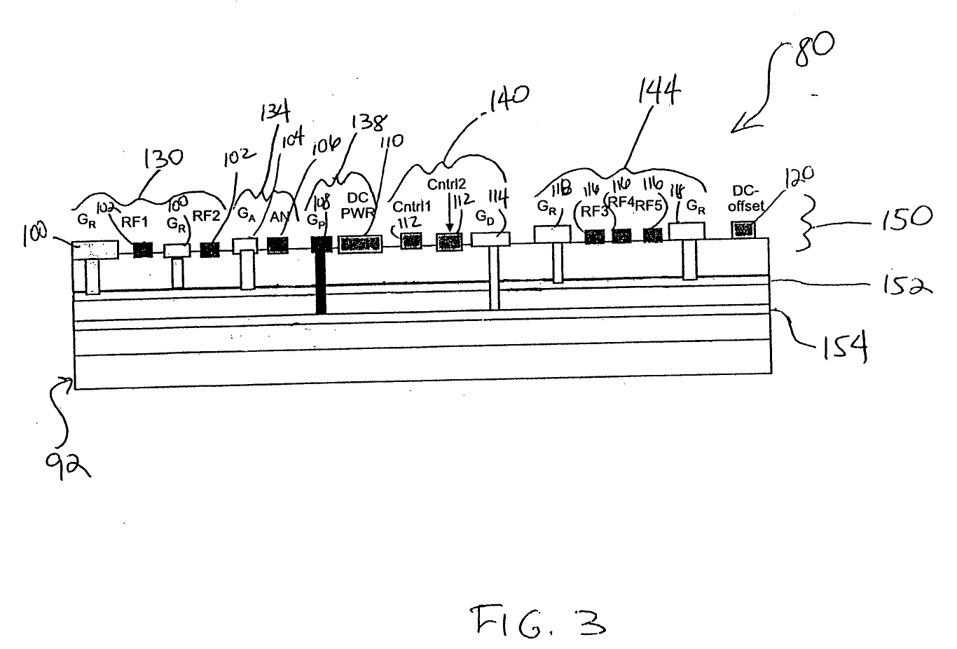

In some embodiments of the invention, the above-described electrical lines that are depicted in FIG. 2 may be formed in metal layers of the PCB 92. Referring both to FIG. 2 and FIG. 3 (that depicts a cross-section of the signal interface 80), in some embodiments of the invention, the electrical lines that are depicted in FIG. 2 may be formed in an upper signal layer 150 (FIG. 3) of the PCB 92.

The next, lower metal layer of the PCB 92 may be an RF ground plane layer 152 (FIG. 3). The RF ground plane layer 152, in some embodiments of the invention, is connected (by vias) to the ground lines 100 (of the set 138) that form the coplanar waveguides; to the analog ground line 104 (of the set 134); and to the ground lines 118 (of the set 144). Each RF communication line 116 and the portion of the RF ground plane layer 152, which lies directly between the RF communication line 116 forms one of the microstrip lines of the signal interface 80.

The lowest metal layer that is depicted in FIG. 3 forms a DC ground plane layer 154. The DC ground plane layer 154 is connected (by vias) to the ground lines 108 and 114.

Although the electrical communication lines of the signal interface 80 are depicted in FIG. 3 as being formed in one plane (the upper signal layer 150) of the PCB 92, it is understood that in other embodiments of the invention, these communication lines may be located in several different planes, or layers, of the PCB 92 for purposes of achieving a more compact design. For example, in some embodiments of the invention, the DC offset line 120 and/or digital control communication lines 112 may be located in one or more different planes, or layers, of the PCB 92 than the RF communication lines (such as the RF communication lines 102 and 116) of the signal interface 80. Thus, many variations are possible and are within the scope of the appended claims.

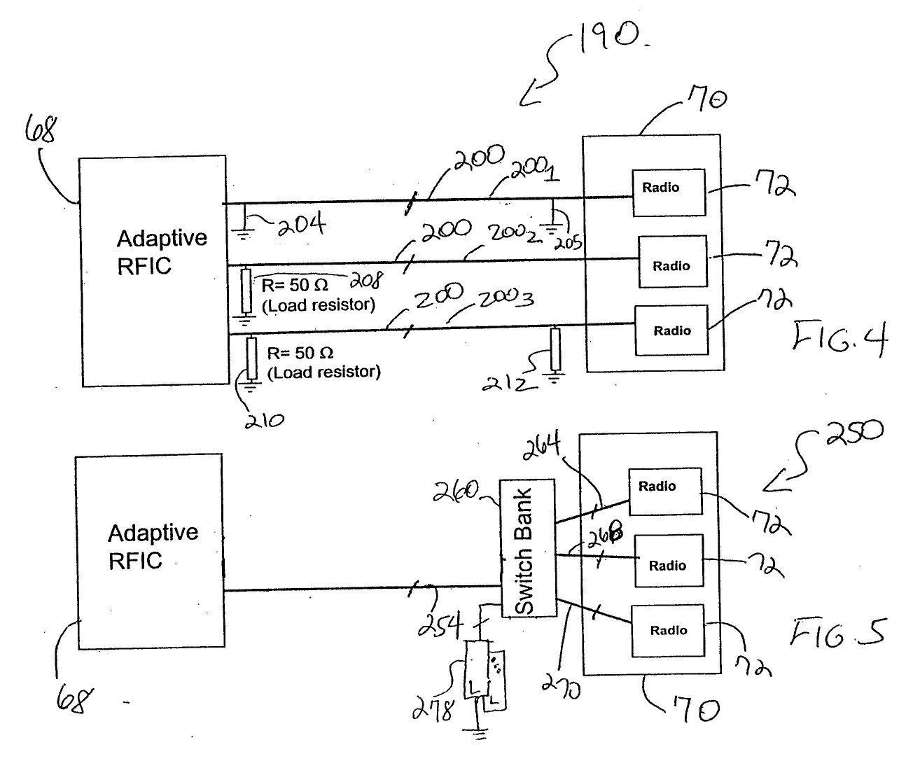

The above-described standardized signal interface 80 may be used in a variety of different ways, depending on the particular embodiment of the invention. FIGS. 4 and 5 depict different network platforms 190 and 250, respectively, which may be implemented as part of a wireless device, such as the wireless device 10 (for example).

Referring to FIG. 4, in some embodiments of the invention, the network platform 190 includes the RF front end device 70 that communicates with the RF integrated circuit 68. As shown, the RF front end device 70 includes multiple (three, for example) radios 72. Each of these radios 72 has a separate communication path with the RF integrated circuit 68. Furthermore, the radios 72 may communicate simultaneously with the RF integrated circuit 68.

More specifically, in some embodiments of the invention, each radio 72 communicates with the RF integrated circuit 68 over a standardized signal interface 200. In some embodiments of the invention, each signal interface 200 may be identical to the signal interface 80 (see FIG. 2). Thus, three standardized signal interfaces 200₁, 200₂ and 200₃ are depicted in FIG. 4, each of which has the same structure (as indicated by each one also being assigned reference numeral 200) and connects a different radio 72 to the RF integrated circuit 68.

Although each signal interface 200₁, 200₂ and 200₃ is the same, the radios 72 may use different lines of their associated signal interface. For example, the radio 72 that is connected to the signal interface 200₁ may use only four lines of the signal interface 200₁ due to the specific connections that are required by the radio 72: the radio 72 that is connected to the signal interface 200₃ may use only eight lines of the signal interface 200₃ due to the specific connections that are required by this radio 72; etc. As another example, one of the radios 72 may use only the microstrip lines and not the coplanar waveguides for its communication with the RF integrated circuit 68, while another radio may use coplanar waveguides and not microstrip lines. Another radio 72 may, for example, use the digital control lines, while another one of the radios 72 may not use these lines. Thus, the use of one of the signal interfaces 200₁, 200₂ and 200₃ by a particular radio 72 depends on the type of radio 72 and how the manufacturer of the RF front end device 70 intended communication with that radio 72.

For purposes of using a single standardized signal interface for each of the radios 72, the lines of each signal interface 200₁, 200₂, and 200₃ that is not being used are terminated. This termination may be through the use of, for example, RF termination loads (50 ohm loads, for example), may be through a coupling to ground and/or may be through a coupling to a supply line, depending on the particular embodiment of the invention. Therefore, although the same standardized signal interface 200₁, 200₂, or 200₃ is used to couple each radio 72 to the RF integrated circuit 68, different lines may terminated in each signal interface 200₁, 200₂ and 200₃. Furthermore, the types of termination may be different for different unused lines and for different signal interfaces 200₁, 200₂ and 200₃.

As a more specific example, FIG. 4 depicts the termination of at least one unused line of the signal interface 200₃. As shown, at the end of the signal interface 200₃ near the RF integrated circuit 68, one of the unused lines of the signal interface 200₃ is terminated with a terminating resistor 210 (a 50 ohm RF terminating resistor, for example); and at the end of the signal interface 200₃ near the RF front end device 70, the other end of this same line may be terminated with another terminating resistor 212 (another 50 ohm RF terminating resistor, for example). Other unused lines of the signal interface 200₃ may be terminated in a similar manner (not shown in FIG. 4, for purposes of simplifying the description).

As another example, the ends of an unused line of the signal interface 200₁ is terminated by connecting these ends to ground, as shown at reference numerals 204 and 205. Other unused lines of the signal interface 200₁ may be terminated in a similar manner (not shown in FIG. 4, for purposes of simplifying the description).

Additionally, other unused lines of the signal interface 200₁ may be terminated in ways (through a terminating resistor, for example) other than through a ground connection, and other unused lines of the signal interface 200₃ may be terminated in ways (through a ground connection, for example) other than through a terminating resistor. Furthermore, in some embodiments of the invention, terminating resistors, such as the resistor 210, may be present as part of the RF integrated circuit 68. Thus, the resistor 219 may be part of the output impedance of the RF integrated circuit 68, and the other resistor 212 may be used to terminate an unused line. This is further depicted in FIG. 4, in that such a terminating resistor 208 may be connected to a line that is used in the signal interface 200₂. Therefore, many variations are possible and are within the scope of the appended claims.

Referring to FIG. 5, in some embodiments of the invention, the network platform 250 may be used when multiple radios of the RF front end device 70 are not simultaneously active. In the network platform 250, each radio 72 is activated to the exclusion of the activation of the other radio 72. Thus, only one radio 72 of the RF front end device 70 is active (and thus, can communicate with the RF integrated circuit 68) at a particular time. Due to this feature, communication between the RF front end device 70 and the RF integrated circuit 68 occurs only through a single standardized signal interface, such as a signal interface 254. In some embodiments of the invention, the signal interface 254 is identical to the signal interface 80 (see FIG. 2).

Due to the single signal interface 254, the network platform 250 includes a switch bank 260 to 1.) select the radio 72 that communicates over the signal interface 254 with the RF integrated circuit 68; and 2.) terminates the unused lines of the signal interface 254. Thus, the switch bank 160, in response to a particular radio 72 being active, couples this radio 72 to the signal interface 254. More specifically, in some embodiments of the invention, the switch bank 260 terminates the unused lines through terminating resistors 278, although other terminating techniques may be used in other embodiments of the invention. Depending on the particular embodiment of the invention, the processor 54 and/or the RF integrated circuit 68 may control the operation of switch bank 260. Although FIG. 5 depicts termination at the end of the signal interface 254 near the RF front end device 70, it is understood that in some embodiments of the invention, the switch bank 260 may alternatively terminate each unused line closer to the RF integrated circuit 68 than to the RF front end device 70. Therefore, many variations are possible and are within the scope of the appended claims.

As depicted in FIG. 5, the connections between the switch bank 260 and the specific radio 72 is tailored for the specific radio 72. Thus, potentially different communication interfaces 264, 268 and 270 link the switch bank 260 to the different radios 72. For example, the interface 264 may be four lines, the interface 268 may be only ten lines, the interface 270 may use microstrip lines and not planar wave guides, etc. However, regardless of the specific interfaces required for each radio 72, each radio 72 communicates over the same signal interface 254, with the unused lines being terminated by the connections that are made by switch bank 260.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
selectively coupling lines of a signal interface to a radio frequency front end device and a device other than the radio frequency front end device; and
terminating unselected lines of the signal interface.

2. The method of claim 1, wherein said device other than the radio frequency front end device communicates one of a radio frequency signal and an intermediate frequency signal with the radio frequency front end device over the signal interface.

3. The method of claim 1, wherein said device other than the radio frequency front end device converts a signal from the radio frequency front end device into a baseband signal.

4. The method of claim 1, further comprising:
communicating at least one of a radio frequency signal and an intermediate frequency signal over the signal interface.

5. The method of claim 1, further comprising:
communicating over at least one of microstrip lines and coplanar waveguide lines of the signal interface.

6. The method of claim 1, wherein the act of selectively coupling comprises:
selectively coupling the signal interface to a first radio of a plurality of radios of the radio frequency front end device in response to the first radio being active.

7. The method of claim 1, wherein the terminating comprises coupling at least one of the unselected lines to ground.

8. The method of claim 1, wherein the terminating comprises coupling at least one of the unselected lines to a terminating resistor.

9. A method comprising:
providing a plurality of signal interfaces for communication between a radio frequency front end device and a device other than the radio frequency front end device, each interface having the same layout of conductive traces; and
for each radio of the radio frequency front end device, coupling the radio to a different one of the signal interfaces.

10. The method of claim 9, further comprising:
terminating unused lines of the signal interfaces.

11. The method of claim 10, wherein the terminating comprises at least one of coupling at least one of the unused lines to ground and coupling at least one of the unused lines to a terminating resistor.

12. The method of claim 9, wherein at least two of the radios use different lines of the signal interfaces to which said at least two radios are coupled.

13. The method of claim 9, further comprising:
communicating at least one of a radio frequency signal and an intermediate frequency signal over at least one of the signal interfaces.

14. The method of claim 9, further comprising:
communicating over at least one of microstrip lines and coplanar waveguide lines of at least one of the signal interfaces.

15. An apparatus comprising:
a signal interface to form a communication link between a radio frequency front end device and a device other than the radio frequency front end device, the signal interface comprising terminated lines not used in the communication link.

16. The apparatus of claim 15, wherein said device other than the radio frequency front end device communicates one of a radio frequency signal and an intermediate frequency signal with the radio frequency front end device.

17. The apparatus of claim 15, wherein said device other than the radio frequency front end device converts a signal from the radio frequency front end device into a baseband signal.

18. The apparatus of claim 15, wherein the signal interface comprises a plurality of lines to communicate at least one of a radio frequency signal and an intermediate frequency signal.

19. The apparatus of claim 18, wherein said plurality of lines comprises microstrip lines and coplanar waveguide lines.

20. The apparatus of claim 15, wherein the signal interface comprise digital control lines and power communication lines.

21. The apparatus of claim 15, further comprising:
a switch circuit to selectively couple the signal interface to a first radio of a plurality of radios of the radio frequency front end device in response to the first radio being active.

22. An apparatus comprising:
a plurality of signal interfaces to provide communication between a radio frequency front end device having radios and a device other than the radio frequency front end device, each signal interface having the same layout of conductive traces, and each radio being coupled to a different one of the signal interfaces.

23. The apparatus of claim 22, wherein the unused lines of the interfaces are terminated.

24. The apparatus of claim 22, wherein at least two of the radios use different lines of the signal interfaces to which said at least two radios are coupled.

25. The apparatus of claim 22, wherein each of the signal interfaces comprises lines to communicate a radio frequency signal.

26. The apparatus of claim 25, wherein said lines to communicate radio frequency signals comprise microstrip lines and coplanar waveguide lines.

27. The apparatus of claim 22, wherein each of the signal interfaces comprises lines to communicate an intermediate frequency signal.

28. A system comprising:
a radio frequency front end device;
a wireless interface coupled to the radio frequency front end device;
a second device other than the radio frequency front end device; and
a signal interface to form a communication link between the radio frequency front end device and the second device, the radio communication interface comprising terminated lines not used in the communication link.

29. The system of claim 28, wherein the wireless interface comprises a dipole antenna.

30. The system of claim 28, wherein the signal interface comprises microstrip lines and coplanar waveguide lines.
